(19) United States
(12) Patent Application Publication
(10) Pub. No.: US 2021/0089945 A1
(43) Pub. Date: Mar. 25, 2021

(54) Method and Machine for Predictive Animal Behavior Analysis

(71) Applicant: Andy H. Gibbs, Tucson, AZ (US)

(72) Inventors: Andy H. Gibbs, Tucson, AZ (US); Suranjan De, Redondo Beach, CA (US)

(73) Assignee: Andy H. Gibbs

(21) Appl. No.: 17/028,395

(22) Filed: Sep. 22, 2020

Related U.S. Application Data
(60) Provisional application No. 62/904,544, filed on Sep. 23, 2019.

(51) Int. Cl. G06N 5/04; A01K 29/00; G06N 20/00; G10L 13/027; A01K 13/00

(52) U.S. Cl. CPC G06N 5/04; A01K 29/005; A01K 13/00; G10L 13/027; G06N 20/00

(57) ABSTRACT

A system for predictive animal behavior analysis for recommending deliverables for a pet based on the pet's behavior and helping a guardian of the pet understand the needs of the pet. The system generally includes a sensor that acquires a pet behavior data of a pet, a database storing a plurality of pet behaviors and a plurality of corresponding deliverables, and a server computer in configured to compare the pet behavior data to the plurality of pet behaviors in the database to identify a selected deliverable from the plurality of corresponding deliverables that corresponds to the pet behavior data. The selected deliverable is then communicated to the guardian which may be purchased by the guardian. In another embodiment, the server computer is configured to inform the guardian of the pet regarding the wants and needs of the pet.

### CROSS REFERENCE TO RELATED APPLICATIONS

I hereby claim benefit under Title 35, United States Code, Section 119(e) of U.S. provisional patent application Ser. No. 62/904,544 filed Sep. 23, 2019 (Attorney Docket No. GIBB-090). The 62/904,544 application is currently pending. The 62/904,544 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a predictive animal behavior analysis system for recommending deliverables for a pet based on the pet's behavior and helping a guardian of the pet understand the needs of the pet.

### Related Art

Any discussion of the related art throughout the specification should in no way be considered as an admission that such related art is widely known or forms part of common general knowledge in the field.

Amazon changed the game of selling online by developing computer algorithms to predict what products a customer might want to buy by analyzing the historical buying habits of each individual online buyer against habits of that buyer's online activity history and also against a large cohort of online buyers, correlating many parameters unique to each, and to many buyers, and predicting each buyer's likes, dislikes, interests, similarity to other online buyers and their unique online purchasing or browsing habits to then form a profile predictive of what each individual may be interested in buying.

Machine learning therefore evolved to self-learn from data gathered for each customer's historical buying and browsing habits to form a unique profile of each person, and correspondingly the creation of a curated list of products the customer was likely to buy. The customer data mining process just described is referred to as “Predictive Consumer Behavior Analytics”, the machine output being referred to as a “Product Recommendation Engine”.

However, when a customer searches an ecommerce website for products for a pet (e.g. dog, cat), the search results will be based on predictive consumer behavior, not the pet's behavior and therefore nearly always includes products that have no relevance whatsoever to their unique pet.

Those skilled in the art will appreciate a product and service recommendation engine modeled along the lines of the Predictive Consumer Behavior Analytics engines now popular in the online industry, but which would use Predictive Pet Behavior Analytics rather than the behavior of the pet owner to more accurately curate and recommend products and services that the pet would want or need.

### SUMMARY

An example embodiment is directed to an animal behavioral analysis system that comprises devices that acquire data related to each pet, communicates the data to a central database on a network, uses rules based analysis of the data to identify behaviors unique to each pet, applies machine learning to predictively identify the needs and wants of each pet, and provides for curating a large inventory of pet products and services to specifically identify only the appropriate products and services indicated, and none of the products and services that do not apply to the pet. The behavioral analysis system further correlates each unique pet's wants and needs to a library of phrases recorded in human language, and initiates the playing of the phrase in human language through a smart speaker such that the pet's guardian understands with a high degree of certainty what the pet is asking for or needs.

One exemplary embodiment provides for the collection and analysis of static and dynamically generated data, derived data and meta data on each pet (e.g. cat, dog) of a large cohort of pets and at least one expert knowledge system, and the algorithmic analysis of the collected data and expert knowledge system, all of which comprise pet behavior and determinants of behavioral change, the machine output thereby creating a unique library of remotely identifiable behaviors for each pet.

There has thus been outlined, rather broadly, some of the embodiments of the method and machine for predictive animal behavior analysis in order that the detailed description thereof may be better understood, and in order that the present contribution to the art may be better appreciated. There are additional embodiments of the method and machine for predictive animal behavior analysis that will be described hereinafter and that will form the subject matter of the claims appended hereto. In this respect, before explaining at least one embodiment of the method and machine for predictive animal behavior analysis in detail, it is to be understood that the method and machine for predictive animal behavior analysis is not limited in its application to the details of construction or to the arrangements of the components set forth in the following description or illustrated in the drawings. The method and machine for predictive animal behavior analysis is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is an exemplary diagram illustrating the range of human-like emotions exhibited by dogs as an example pet in accordance with an example embodiment.

FIG. 2 is an exemplary diagram illustrating a representative list of symptomatic indicators of pain being experienced by a dog as an example pet in accordance with an example embodiment.

FIG. 3 is an exemplary diagram illustrating a plurality of body positions a dog may assume when experiencing various emotions or feelings.

FIG. 4 is an exemplary diagram illustrating a plurality of pet data containers, the containers comprising a portion of a pet behavior database in accordance with an example embodiment.

FIG. 5 is an exemplary diagram illustrating a plurality of expert systems of a dog behavior database in accordance with an example embodiment.

FIG. 6 is an exemplary flow chart illustrating the sequence of building dog data to generate a human voice output in accordance with an example embodiment.

FIG. 7 is an exemplary diagram illustrating an exemplary cloud structure for a predictive pet behavior and product recommendation system in accordance with an example embodiment.

FIG. 8 is an exemplary diagram illustrating a flow chart of a pet behavior and products and services recommendation machine in accordance with an example embodiment.

FIG. 9 is an exemplary diagram illustrating a flow chart of a customer analysis system in accordance with an example embodiment.

FIG. 10 is an exemplary diagram illustrating a pet behavior and health anomaly system in accordance with an example embodiment.

FIG. 11 is an exemplary diagram showing an example system and cloud architecture for the data and analytics system for the pet behavior and products/services recommendation machine in accordance with an example embodiment.

FIG. 12 is an exemplary diagram showing variations of a pet behavior system in accordance with an example embodiment.

FIG. 13 is an exemplary diagram showing a system of a recommendation machine in accordance with an example embodiment.

FIG. 14 is an exemplary diagram showing examples of various dog positions and movements that generate unique IoT device data streams and human language output in accordance with an example embodiment.

FIG. 15 is an exemplary diagram showing various possible outputs from the dog behavior and product/service recommendation machine in accordance with an example embodiment.

FIG. 16 is an exemplary diagram showing a table listing benefits of a predictive pet behavior recommendation machine to drive E-commerce revenue in accordance with an example embodiment.

FIG. 17 is an exemplary diagram showing a correlation between a partial list dog characteristics and the correlation of the characteristics to a partial list of categories of dog products and services.

FIG. 18 is an exemplary diagram showing various components of the predictive dog behavior analytics system in accordance with an example embodiment.

FIGS. 19A, 19B and 19C are exemplary diagrams showing a table of data fields in accordance with an example embodiment.

### DETAILED DESCRIPTION

To facilitate an understanding of the description, a discussion of several terms used herein follows. The terms “dog” is used throughout to describe one type of animal or pet for example purposes. The usage of term “dog” is not intended to limit anything herein to only a dog and instead the various embodiments herein may be used with various other types of pets and animals (e.g. cats) without limitation.

“Guardian” as used herein shall mean a permanent or temporary caretaker of a companion animal (e.g. dog, cat), including but not limited to a representative of a dog care facility, the owner of the dog, or a dog owner's custodian or representative.

“Pet Data” as used herein shall mean digital data uniquely associated with an individual dog, the data comprising at least static data not likely to change over time, for instance, a dog's breed or gender, slowly changing data such as the daily-incremented data related to a dog's age, frequently changing data such as day-to-day weather changes, rapid dynamically changing data such as a dog's activity of running or drinking water, derived data created by algorithmic computation of one or more static or dynamic data elements related to an individual dog, and/or meta data manually or automatically created and associated with any pet data elements, any one or more to be considered pet data that may be reasonably used to determine Dog Behavior.

“Dog Behavior” or “pet behavior” as used herein shall mean Pet Feelings as described below, in addition to physically observable movements performed by a dog such as, but not limited to the acts of eating, drinking, running, walking, jumping, barking, growling, meowing, purring, shaking, scratching, sleeping, tail wagging, ground-pawing of digging, wriggling, and yawning. Pet behavior further includes difficult to observe or non-observable behaviors discovered through the mining and analysis of data collected from one or more sensors associated with a unique pet and include, but are not limited to changes in a physiological condition determined through computational analysis of before and after condition change data, a change in observable behaviors caused by a non-observable physiological change such as an illness, or a change in the pet's environment including temperature or weather change or solunar changes. Pet behavior further includes time-dependent observable and non-observable characteristics of a pet which may include, but are not limited to age related biological and/or physiological change and/or long-term analysis of Pet Data to establish trends and trend deviations. Further, pet behavior may include results of regression analysis of the behavior of a subject pet within a large cohort of corresponding type of pets (e.g. if the subject pet is a dog, the results will be based on data corresponding to other dogs), the cohort determined by any one or more prescribed parameters necessary to conduct the analysis. Finally, pet behavior as used herein shall also include idiopathic responses to stimuli and/or psychological conditions that parallel human obsessive compulsive disorders such as constant licking the front paws, constant scratching, yawning or chewing.

“Pet Feelings” as used herein shall mean emotional feelings including but not limited to anxiety, fear, disgust, joy, love, contentment, as well as physical feelings including but not limited to pain, vigor, tiredness, thirst, or the urgency to relieve themselves.

“Determinants of Behavioral Change” as used herein shall mean changes in dog behavior as used herein, the changes determined by analysis of at least two discrete data elements related to any individual dog whether the data elements are static, dynamically changing, comprise meta data, or data elements derived from the analysis of Pet Data and/or one or more Expert Systems.

“Sensors” as used herein shall mean any device enabling the collection of data from the pet including, but not limited to, analog devices from which analog-to-digital conversion will produce digital data. The sensors may be comprised of any device capable of recording data corresponding to the pet including but not limited to accelerometers, GPS receivers, magnetometers, pressure sensors, distance measuring sensors, proximity sensors, vibration sensors, cameras, active and/or passive RFID and/or Near Field Communication (NFC) devices, biometric sensors, audio sensors and microphones, light sensors, and other sensors not specifically mentioned capable of collecting Pet Data.

“Expert System” as used herein shall mean a computer device and software designed to solve complex problems by reasoning through bodies of knowledge, the expert systems being used to create decisions directly related to individual Pet Data, and further the expert systems receiving data input received from Sensors that intelligently accurize the body of knowledge over time. More specifically, expert systems herein may include a body of knowledge known in the veterinary medicine community as a symptomology library that identifies dog illness symptoms with a hierarchically organized list of probable underlying causation. Another expert system may include a body of knowledge related to anatomical measurements, and the range of measurements of anatomical features of each breed or mixed breed of dogs, for instance, the variations in cranial measurements as described in “Cranial dimensions and forces of biting in the domestic dog” Ellis, et. al., Journal of Anatomy (1629) 214, pp 362-373. For context, the cranial measurement and forces expert system may be used to correlate specific products from a large collection of products to each dog, for instance, a big hard dog toy would correlate to a large skull, high bite force dog, while a small soft toy would correlate to a small diameter, soft fluffy toy. Therefore, many expert systems should be anticipated as meaning an expert system herein comprising a body of knowledge including but not limited to canine anatomy, dog symptomology, local weather and environment, dog behaviors, and energy and hydration tables for predicting food and water requirements.

“Pet Behavior Machine” as used herein shall mean an artificially intelligent software program that analyzes pet data and one or more expert knowledge systems to create a unique tangible definition of the learned behaviors of each dog, thereby defining a unique digital behavioral profile for each dog.

“Recommendation Machine” as used herein shall mean an artificially intelligent software program that correlates unique animal behaviors to a large table of products and/or services (collectively “deliverables”) to produce a unique tangible list of products and/or services appropriately individualized to each animal's behavioral profile.

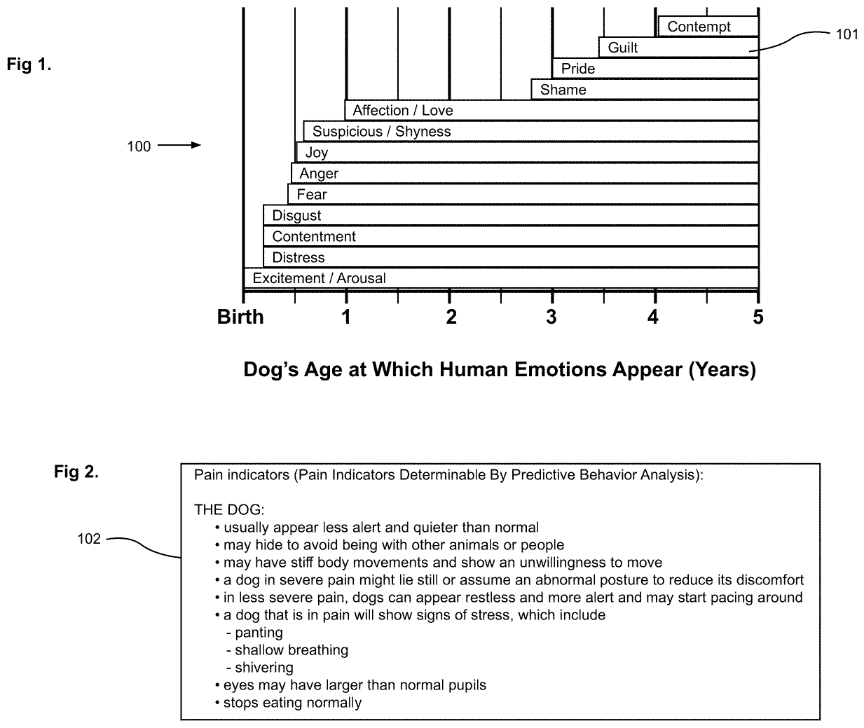

FIG. 1 is an exemplary diagram 100 illustrating the range of human-like emotions exhibited by dogs. Dogs can't talk. However, those skilled in the art recognize that dogs experience pain, as well as many of the same emotions experienced by humans as is well documented. Further, the ability to exhibit these emotions develop at various times after birth. For instance, a dog's ability to exhibit guilt 101 will generally develop at about 3½ years old. The ability of dogs exhibiting emotions is supported by a substantial body of works by domain experts including for instance Stanley Coren PhD., DSc, FRSC in “Which Emotions Do Dogs Actually Experience?”, Psychology Today, MR 14, 2013.

Sellers of products and services to humans have historically appealed to human emotions to help increase sales. For instance, humans will purchase greeting cards and flowers to express their affection and love for another. If merchants could identify dog emotions, which historically they could not, then these merchants could realize a considerable increase in sales revenue.

Now, by correlating the data related to the position and movements of a dog to the expression of each of the emotions, a database of learned data predictive of each behavior can now be created. Thereafter, the database receiving a data stream from sensors placed on and proximal to a dog and which data is sent to the database via a communication network, the data being statistically similar to the data stream correlated with each or any of the emotions can predict the current emotional state of any dog.

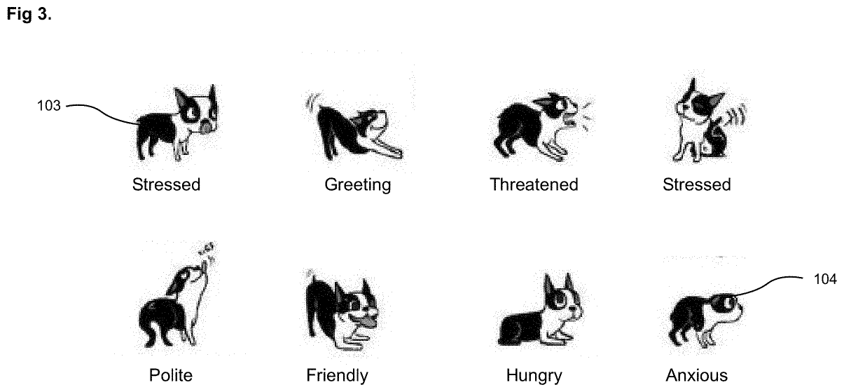

FIG. 2 is an exemplary diagram illustrating a representative list 102 of symptomatic indicators of pain being experienced by a dog. As those in the veterinary field will appreciate, various symptoms are exhibited by a dog when it is in pain. For instance, as listed in the drawing, a dog in pain will be less alert and act quieter, may hide to avoid being with people, may pant more than normal, and may stop eating normally. Each of these pain indicators, as well as myriad other behavior indicators may be accurately identified once a body position or condition is reliably correlated to predicted dog behavior data. More specifically, daily activity data collected from a sensor-enabled dog collar, and data collected from sensor enabled dog water and food bowls provide for a data profile for each unique dog. In the novel pet behavior system, the data trends related to each of the sensors and all of the sensors together will yield a predictive health indication, and will likewise yield an alert or warning when data deemed out of the normal range, or when anomalous data is identified.

For instance, in the pain indicators listed in the chart 102, a significant decline in dog collar data is indicative of a dog being “less alert and quieter than normal”. Further, the collar data, representing shorter duration but higher acceleration data streams would be indicative of “stiff body movements”. Further, having established a reliable trend of food and water consumption as a result of daily data collection from sensor enabled food and water bowls, a data stream showing an anomalous decline in water or food consumption would indicate that the “dog stops eating normally”.

The pain indicators being contained in an expert system would be correlated to a dog's data profile that, after analysis is determined to be anomalous data, and a positive making learned correlation would then trigger the artificially intelligent machine to alert the guardian of the machine learned conclusion that the dog is in pain.

Such information would therefore activate the recommendation machine and organize products and services that positively correlate with pain medicaments, veterinary medical care treatments or therapies, the recommendations being delivered to the dog's guardian electronically by one of many means including but not limited to voice, text, email or other audible or visual indicia.

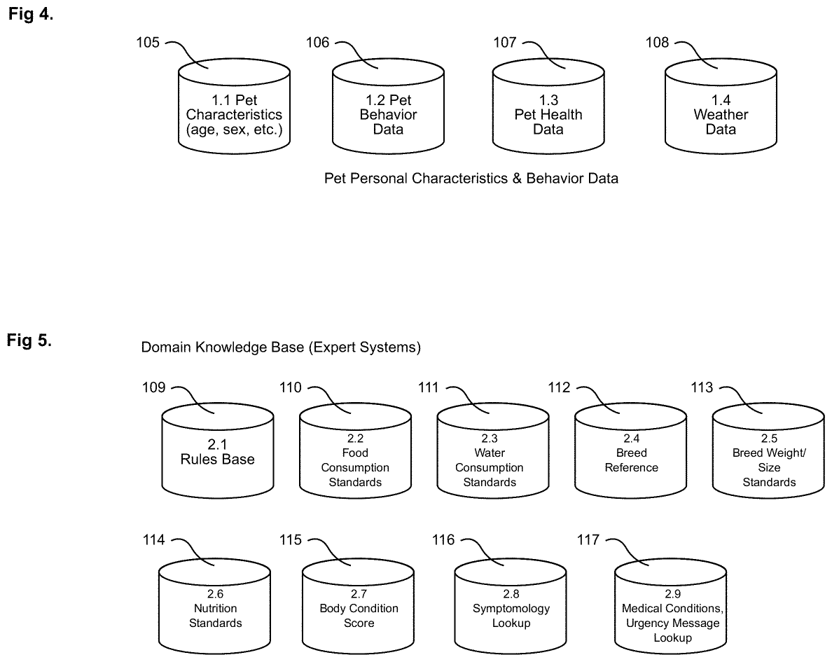

FIG. 3 is an exemplary diagram illustrating a plurality of body positions a dog may assume when experiencing various emotions or feelings. As can be readily appreciated by those skilled in the art, by means of digitally capturing the position and motion through the use of video motion capture, a process well known in the video gaming industry and cinematography industry, a video of a dog exhibiting each of the show positions may be recorded. Further, by simultaneously capturing collar sensor data at the time that each body position is being exhibited, a data stream uniquely identified with each of the dog's positions may be recorded, the data stream thereby being stored in a database as a digital signature associated with each predictably repeatable position. Further, a database correlates the data signature to the corresponding emotion or feeling that resulted in the body position.

However, dogs cannot verbalize to humans their physical or emotional conditions, leaving it to their body language to be subjectively interpreted by their guardians. Unfortunately, the subjective interpretation is seldom correct, and even when occasionally interpreted correctly by humans, there is no method of confirming that the interpretation was correct.

In a novel recommendation machine, deep learning of a dog's various body positions create an artificially intelligent database that uses a data stream from a dog's collar and/or other sensor enabled devices to predict each dog's underlying feelings or emotions at a given instance in time. The database is therefore defined herein as a dog behavior database.

In the drawing, a stressed dog 103 will exhibit body language that includes stiffness, and frequently idiopathic behaviors such as incessant licking, all of which can be identified by correlating the real-time collar sensor data to a machine learning database which contains data signatures indicating a state of stress. On the other hand, if a dog 104 is cowering, moving slowly or in a broken gait as indicated by the sensor data, the data signature, when compared to a machine learning database containing signatures of anxious dog behaviors will remotely predict the exhibition of anxious behavior by the dog. These illustrative examples are not meant to be limiting and merely show two of many dozens of possible behaviors that predictably correlate to pet data signatures in a machine learning database.

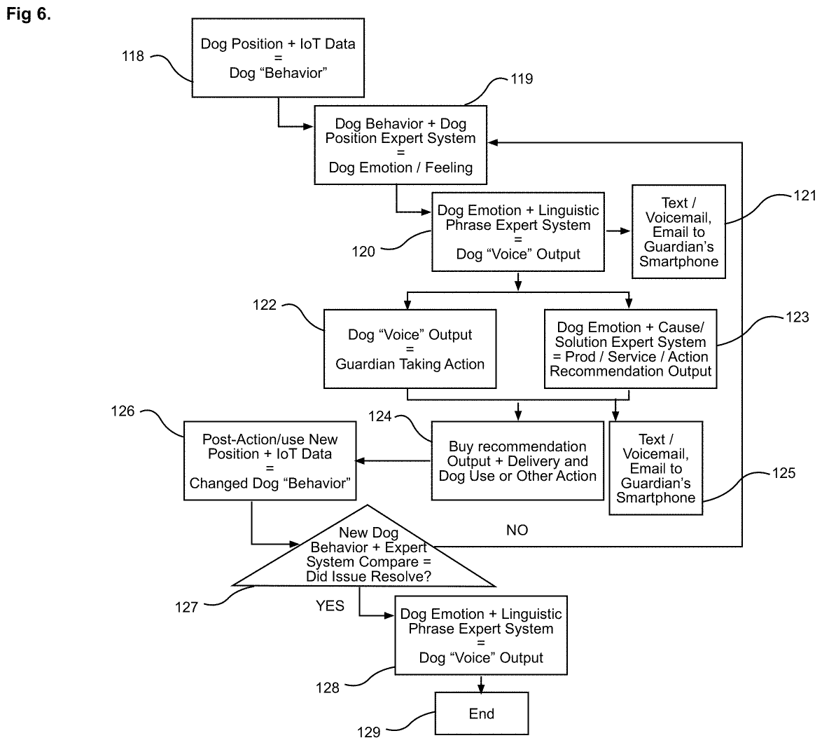

FIG. 4 is an exemplary diagram illustrating a plurality of pet data containers, the containers containing substantially static data such as individual characteristics of a dog that are unlikely to change over time. For instance, a data container 105 may contain a dog's breed, size, sex and date of birth, all of which will reliably remain the same throughout a dog's life. Other data that may change includes the neuter status, which would change only one time, and the dog's age which would increment one day each day following birth.

A second container 106 may contain dog behavior data as just described. The dog behavior database is a machine that improves the understanding of the signatures that correlate to each of a large number of behaviors, and would contain the behavior signatures of a large number of dogs, and a large number of body positions and data from one or more sensors upon which analysis is continually performed.

A third container 107 may contain the unique health profile of each dog, the health profiles including but not limited to data that routinely changes over time including the dog's body weight, body condition score (BCS) which is a relative scale to gauge overweight to underweight dogs, and activity level, an indicator of exercise. Various sensors on food and water bowls, motion sensing cameras or other in-home sensors may provide additional data feeds that would contribute to the analysis of a dog's health profile. Other data that may be associated with each given dog, for example, may be weather data 108 provided by a localized weather data feed.

Therefore, the novel recommendation machine provides for the collection and analysis of static and dynamically generated data, derived data and meta data on each dog of a large cohort of pet dogs and at least one expert knowledge system, and the algorithmic analysis of the collected data and expert knowledge system, all of which comprise Dog Behavior and Determinants of Behavioral Change, the machine output thereby creating a unique library of remotely identifiable behaviors for each dog.

In lay terms, the novel recommendation machine provides for identifying each unique dog's wants, needs or desires.

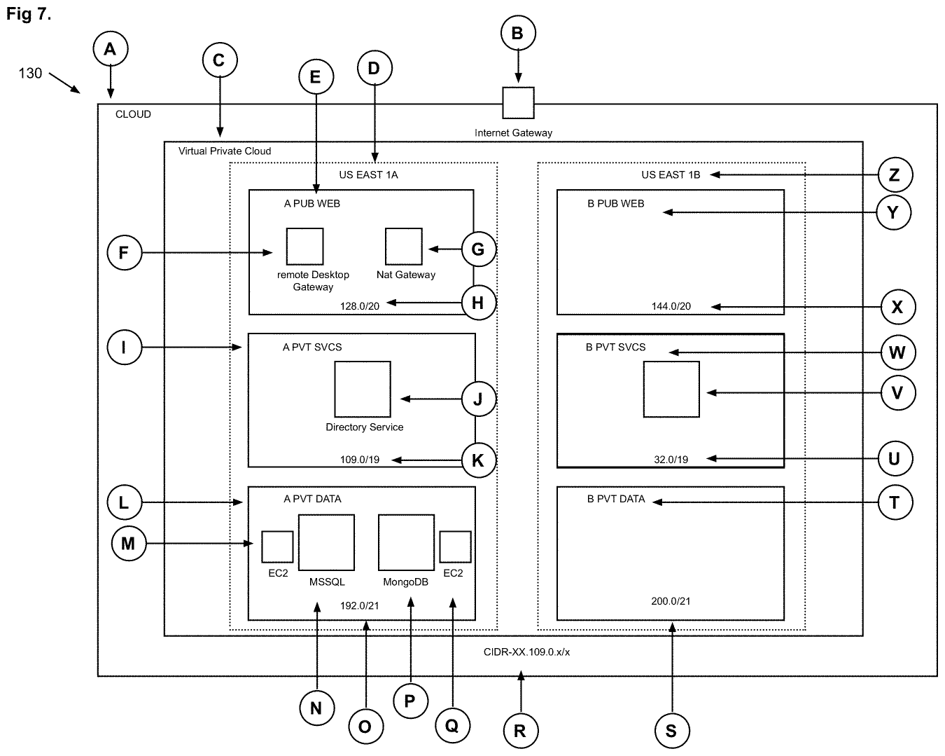

FIG. 5 is an exemplary diagram illustrating a plurality of expert systems, the expert systems being a repository of industry recognized and/or standardized information stored on a computer such as but not limited to a list of dog breeds 112 with the associated predicted adult sizes and weights 113, a list of symptoms 116 related to typical illnesses, injuries, afflictions, conditions or diseases that may be exhibited by dogs during their lifetime. Food consumption 110, water consumption 111 and nutrition standards 114 expert system would preferably be expressed in milliliters (ml) of water and kilocalories (kcal) of food energy that would be consumed by a given size and weight dog based on a given level of daily activity, the kcal data being used to predict the appropriate daily food portion to maintain a healthy weight, the weight correlating to body fat content typically expresses as a Body Condition Score (BCS) 115. Those skilled in the art will appreciate that the knowledge contained in each of the knowledge bases represents known conditions, medical conditions, and standards of care well known in the veterinary industry.

Further, one expert system contains a plurality of rules 109, computer operated algorithms that poll and use various data from one or more expert systems to produce a result, the result being one of an unlimited data outputs related to each individual dog, for example, the outputs including but not limited to the predicted preferable healthy weight, predicted daily food consumption in kcal, predicted cranial dimensions or other anatomical features, the identified symptoms of an illness 116 being experienced by the dog, or the change in any behavior or nutritional requirements that may trigger the autonomous actuation of another computed program, or may trigger an informational message 117 to the dog's guardian. There is no practical limit to the number and types of rules algorithms that may be performed on the computer, and no practical limit to the types of or numbers of expert systems that may provide raw or processed data to any rules engine.

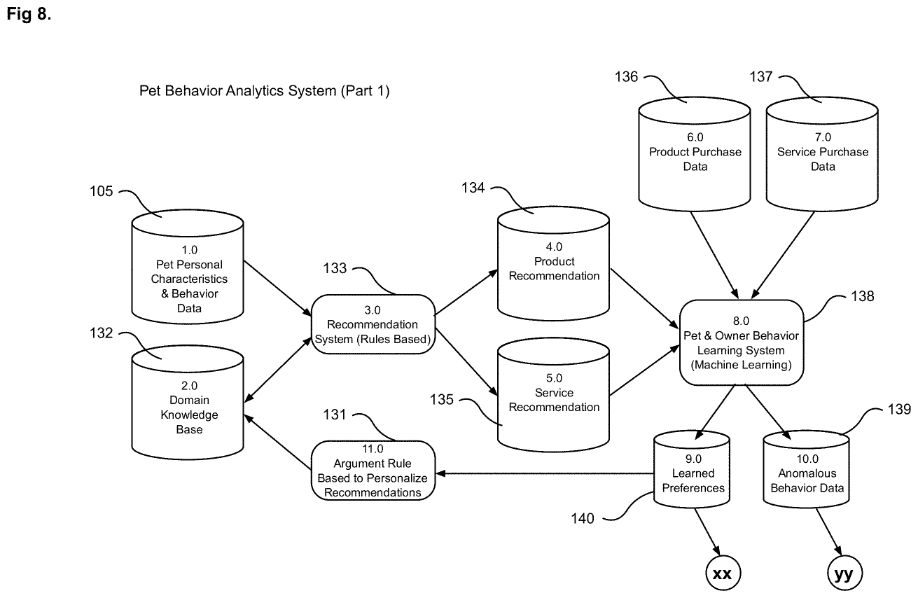

FIG. 6 is an exemplary flow chart illustrating the sequence of building pet data to create a human voice output that correlates positively with a pet's wants and/or needs. Dog behavior 118 is preferably defined as a dog's position and/or movement as captured by a plurality of video motion capture cameras, the position and/or motion synced to a data stream of data from one or more Internet of Things (IoT) devices associated with the dog during the performance of the position and/or movement. Taken a step further, the dog's emotion or feelings 119 are derived by correlating the dog behavior with an expert system that has machine learned particular movements and positions indicative of specific behaviors that are also well recognized by the veterinary community.

The dog behavior and the emotion can now be associated with an expert system containing a library of recorded natural language phrases 120 that are associated with each behavior. The defined phrase can thereafter be played through a speaker device such that the dog's emotion can be communicated to the guardian 121 by means of understandable human language. The voice may be associated with the dog's need or desire with a call to action 122 from the guardian. If the need or desire is, for example, the need to go outside to go pee, the phrase may be “I need to go pee now”. On the other hand, if the need or desire is for a toy, or a particular food flavor, the phrase may be “I prefer chicken over lamb, can you order chicken the next time?” 123 prompting the guardian to order the chicken flavored food the next time. Further, when the guardian logs into the ordering website through which the plurality of products are curated and prioritized by the recommendation machine, with a buy-action 124 recommending the chicken flavored food above other products since the dog has “voiced it's preference” via an avatar voice for chicken, and/or communicated to the guardian by other well-known means 125.

In the instance of food flavor preference, it is well known in the industry that the speed of food consumption correlates positively with a food preference compared to a food consumed more slowly. The IoT data received from a smart food bowl provides the comparative data associated with different food flavors, therefore providing the basis for making the recommendation for the food consumed faster. Further, and merely as one example, upon eating the chicken flavored food more quickly than the previous consumption time for eating lamb flavored food, the novel recommendation engine replaces the lamb food preference with the dog's new “request” for chicken 126, the smart bowl data is then compared to the data associated with the previous lamb food.

Machine learning analyzes whether the chicken is now consumed at a faster rate than the previous lamb 127.

If YES, the dog displays its pleasure by triggering a phrase “I like this food much better” 128 that is played through a speaker device and the instant analytical process ends 129.

If NO, the machine will determine that the dog's data does not indicate pleasure 119 and reiterates the process to recommend yet a different food until the machine determines that the current food is preferred over all previous food flavors. Upon voicing pleasure, the program ends, with the system looking for the next behavior and emotion that triggers the need for the dog to “voice” its feeling or desire.

It should be noted that the output of the emotion may be an electronic message sent to the guardian by well-known means such a voicemail, email, text, or a pop up alert when the guardian logs in to the website riven by the system of the present invention.

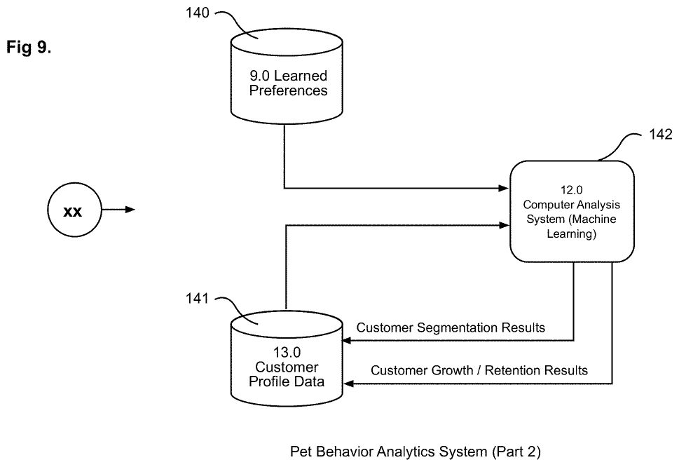

FIG. 7 is an exemplary diagram illustrating the cloud structure 130 for a predictive pet behavior and product recommendation system preferably comprising:

A. AWS Cloud: A novel recommendation machine preferably uses an Amazon Web Services (AWS) or comparable Cloud Platform to develop, test, manage, and execute the functions of the recommendation machine.

B. Internet Gateway: An internet gateway is a horizontally scaled, redundant, and highly available Virtual Private Cloud (VPC) component that allows communication between instances in a VPC and the internet.

C. Virtual Private Cloud: A logically isolated section of the Cloud where one can launch AWS resources in a virtual network that you define.

D. US-EAST-1A: Availability Zone within an AWS region which is an isolated location (datacenter) within an AWS Region. This allows for high availability and fault tolerance for resources deployed in AWS.

E. A-Public-Web: Public subnet for resources like web servers that route directly through an internet gateway.

F. T3 Remote Desktop Gateway: Secure RDS Jump box to allow management of AWS resources.

G. NAT Gateway: A network address translation (NAT) gateway to enable instances in a private subnet to connect to the internet or other AWS services, but prevent the internet from initiating a connection with those instances

H. 10.109.128.0/20: CIDR range for subnet.

I. A-Private-Services: Private subnet for application servers that may need to access the internet but must access through a NAT Gateway.

J. AWS Directory Service: AWS Managed Active Directory environment for managing permissions and access to resources within AWS.

K. 10.109.0.0/19: CIDR range for subnet.

L. A-Private-Data: Private subnet for databases. No routes allowed to public internet and secured by security groups to specific application services for security.

M. M5 (EC2)—EC2 Instance class for MSSQL database.

N. MSSQL: Microsoft SQL Database server on EC2.

O. 10.109.192.0/21: CIDR range for subnet.

P. M5 (EC2)—EC2 Instance class for MongoDB.

Q. MongoDB: Document Database on EC2.

R. CIDR-10.109.0.0/16: Entire CIDR block for VPC.

S. 10.109.200.0/21: CIDR range for subnet.

T. B-Private-Data: 2nd Private subnet for databases for HA design if necessary.

U. 10.109.32.0/19: CIDR Range for subnet.

V. AWS Directory Service: High Available deployment of AWS Directory Services in separate AWS availability zone within an AWS Region.

W. B-Private-Services: 2nd Private subnet for application servers.

X. 10.109.144.0/20: CIDR range for subnet.

Y. B-Public-Web: 2nd public subnet for web servers.

Z. US-EAST-1B: 2nd Availability Zone within an AWS region which is an isolated location (datacenter) within an AWS Region. This allows for high availability and fault tolerance for resources deployed in AWS.

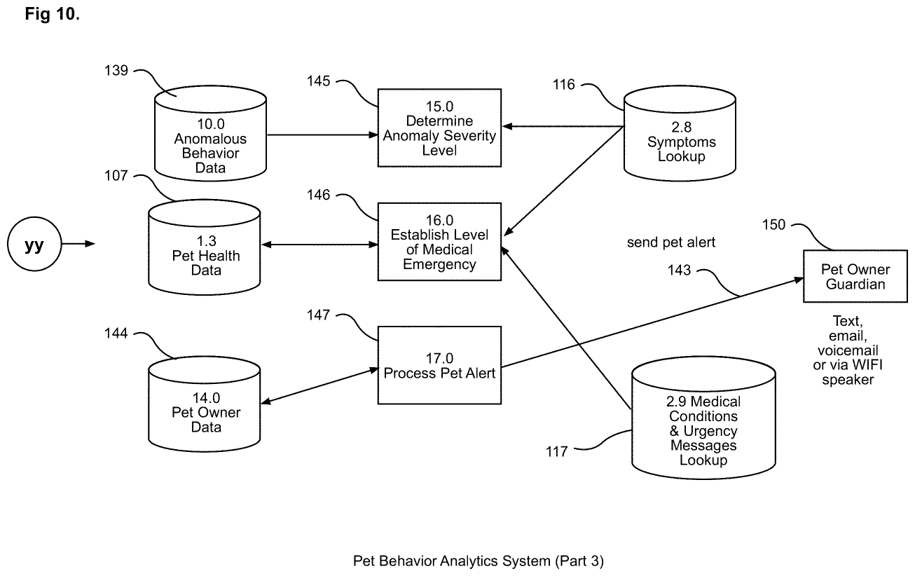

FIG. 8 is an exemplary diagram illustrating a flow chart of a dog behavior and product/service recommendation machine. More specifically, the diagram shows the database relationship and data flow between the databases of the dog behavior and recommendation machine.

A pet characteristics database 105 as previously described and a plurality of expert systems 132 provides pet data and domain knowledge into a recommendation machine 133. The recommendation machine, based on one or more rules algorithms correlates one or more of the pet data to one or more of the expert systems in establishing recommendation parameters for each dog.

The recommendation parameters are sent to a product recommendation list 134 and/or a services recommendation list 135, the two lists thereby being sorted based on meta data associated with each product and service, the sort resulting in the recommendation of the closest products and services matching the needs, wants or desires 138 of the dog being the preferred recommendations.

Future product recommendations that rely on predictive changes in dog behaviors based upon expert knowledge systems such as changes in pet data over time, for instance, predicting behavioral changes at the point when a puppy will become an adult dog, or the point in time that an adult dog becomes a senior or geriatric dog are learned preferences 140.

Based on the recommendation machine's recommendation, a pet guardian will purchase the product 136 or service 137. Following the purchase, a behavior learning system 138 evaluates the dog behavior data before and after receiving the product or service to determine whether the dog is satisfied with the purchase and use. If the product or service benefitted the dog, the preference is stored 140 and the new data updates the domain knowledge base associated with that given product or service to refine the personalization 131.

On the other hand, if the result is unexpected and out of range of an acceptable range of behaviors associated with the product or service, the data would be considered an anomaly 139 with the negative experience data being returned to the dog's profile for consideration in future recommendations.

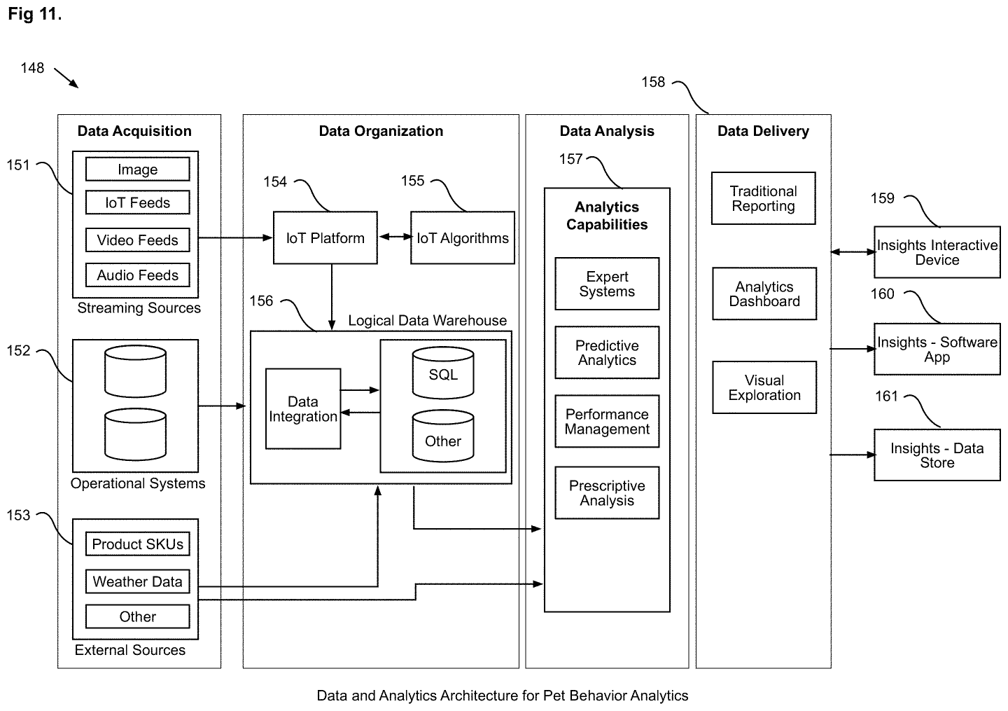

FIG. 9 is an exemplary diagram illustrating a flow chart of a customer analysis system of FIG. 8 comprising the learned preferences 140 of dogs for the product or service recommended by the recommendation machine. The learned preference is communicated to the customer analysis system 142 which learns positive and/or negative attributes of the recommended product or service for future machine reference, the positive or negative data thereafter communicated to the customer profile 141. Those skilled in the art will appreciate that customers who see positive results from their purchases will continue to purchase, and will remain a customer for a longer period of time, recurring sales and revenue, and long-term customer retention being among the most commercially valuable metrics pursued by retailers. It is an important component of customer retention and revenue growth to ensure that the machine learning determines the products and services most beneficial to the dog and correspondingly recommends those more, while at the same time, learning which products not to recommend to the customer or in the future, customers with dogs that share similar characteristics with the dog that had a negative experience with the product or service.

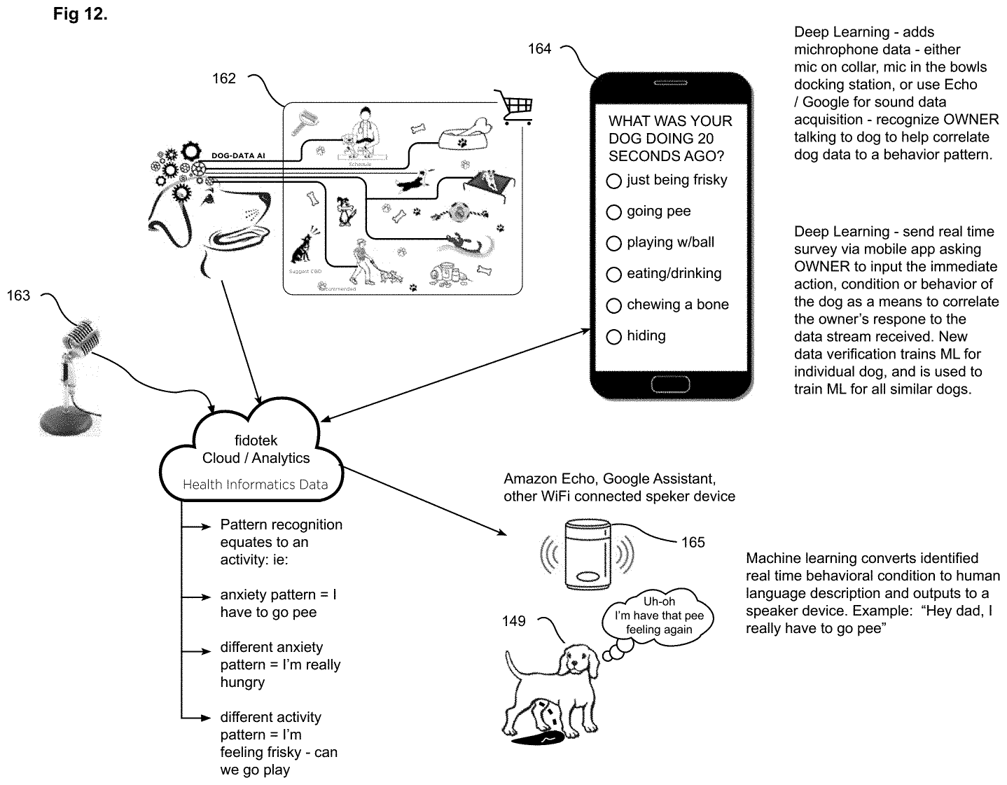

FIG. 10 is an exemplary diagram illustrating a dog behavior and health anomaly system of FIG. 8. More specifically, one database 107 contains the health data of each of many dogs, and a database 144 contains pet owner/guardian data related to each dog. It is sometimes encountered that a dog's health monitoring data will identify anomalous data 138 that may be indicative of a medical problem. The anomalous data, for example, may indicate short bursts of high G-force, high frequency movement not typically encountered in a dog's historical data. This data will require a machine intelligent determination 145 of the severity of the anomaly, and to perform this analysis, the machine polls an expert system, specifically a symptoms lookup table 116 to correlate the anomalous data to known conditions. Not shown but described herein, the recommendation machine further provides for a deep learning correlation between the dog profile data and one or more expert systems, the expert systems including but not limited to at least local weather conditions, veterinary symptomology and/or pet care services including specifically recommended medical treatment and/or therapies intended to ameliorate the learned underlying symptomology.

This process yields a result indicating that the dog has experienced an epileptic seizure. The expert system 116 indicates for instance that there are three general categories of epileptic seizures—occasional, cluster seizures, and grand mal seizures. The expert system adds the present data anomalous data to its database, refining it's machine learning of data signatures associated with epilepsy. Now, the new symptom and cause determination made by machine learning seeks to establish a level of medical emergency 146. It is well known and correspondingly recommended that the guardian should consult with a veterinarian if:

1) the dog has more than one seizure a month, or

2) the dog experiences clusters of seizures where one seizure is immediately followed by another, or

3) the dog experiences a grand mal seizure lasting 5 minutes or less.

However, if the data indicates that the dog experienced a grand mal seizure lasting more than 5 minutes, another expert system is polled to determine the level of urgency 117 the urgency level increases from “make an appointment”, to acute, recommending that immediate care is required.

The recommendation machine as previously described but not shown would then lookup veterinarians to recommend to the guardian, and process an alert message 147 and sends the message 143 electronically to the guardian 150.

As can be readily seen, the example just described is merely one illustration of the process of analyzing pet behavior data and correlating that data with known symptoms to establish a level of urgency, and messaging to the guardian that instructs on the data analytics and recommended course of action, and recommended products or services that should be purchased for the dog. The epilepsy example is not meant to be limiting and the symptoms lookup and medical conditions urgency may contain many hundreds of discrete symptoms and associated possible underlying causes of the symptoms.

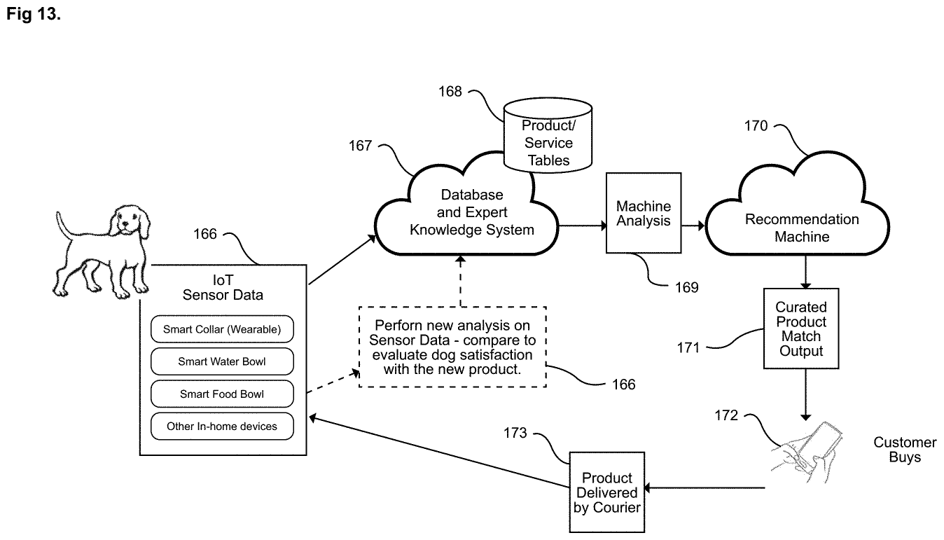

FIG. 11 is an exemplary diagram showing one preferred system and cloud architecture 148 for the data and analytics system for the pet behavior and products/services recommendation machine. In the present invention, dog behavior data is collected 151 via various sources including but not limited to photographic images of each dog, data streams received from one or more IoT devices such as sensor enabled dog collars, food and water bowls and weighing scales, from video feeds such as from motion capture cameras, and audio feeds such as sound capture via one or microphones in the dog's home, including the provision of a microphone on the dog's collar. The data and software is contained on one or more databases 152. Additional data may be provided by or accessed through external sources 153 such a dog product databases, weather data that may be localized for each dog location, or other external data libraries.

The collected data is organized preferably consolidating all of the IoT data 154 collected from all IoT devices associated with each of many dogs. As previously described, a plurality of algorithms 155 may be used to create meta data or derived data from the IoT data. Collected IoT data is stored in a warehouse 156 for integrating and processing/computing against other data including external data 102 using well known databases.

The data analytics processes 157 include machine learning improvement on any or all of the expert systems, predictive analysis to produce various informational results, and prescriptive analysis that produces an output directing an intelligent, preferred course of action.

The results of the analyzed data may be delivered in various formats 158 and on various devices such as traditional reporting, for example, Crystal Reports, output to an analytics dashboard, or other visual data exploration software tools.

Insights from the data output may be delivered back to one or more IoT devices associated with each dog, the output communication being one direction of a two-way communication interaction 159 between IoT devices and the Pet Behavior Analytics system.

Insights may also be communicated 160 to an App on the guardian's smartphone, tablet or other Internet connected appliance.

Finally, the insight results 161 may be generated by the Pet Behavior Analytics System in the form of a data store which can then be shared with external entities (customers, interested third-parties etc.).

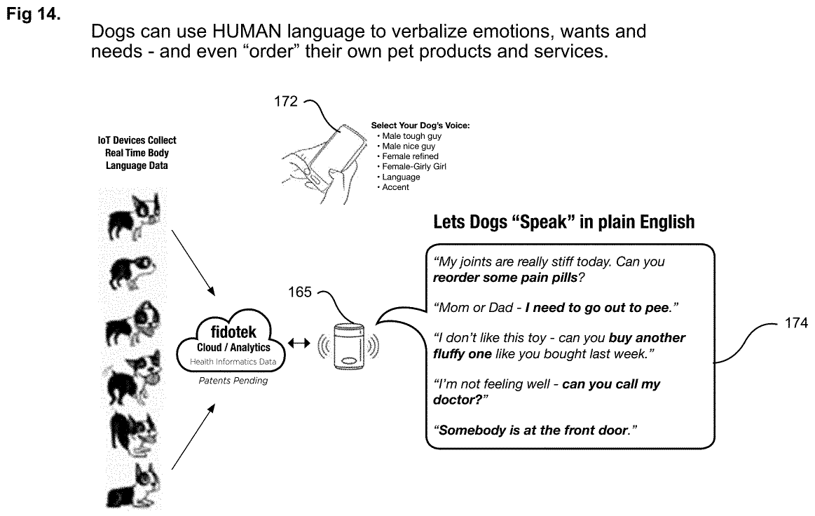

FIG. 12 is an exemplary diagram showing variations of a pet behavior system. As previously described, the pet data is captured from a plurality of IoT devices 162. In one variation, audio data may be captured from one or more microphones 163 that may include a microphone integral to the dog collar. The IoT and microphone data just described is data analyzed with the express purpose of determining data patterns that correlate to individual dog activity within its home environment, for instance, the recorded audio data associated with the guardian's questioning the dog on whether it needs to go outside to pee queuing the behavior algorithms correlating to the dog's behavioral movement data, thereby training the pet behavior system to recognize dog movements associated with the need to go outside to pee 149.

Absent a microphone, or as a verification of dog behavior to assist in training predictive and prescriptive analysis of the dog's behavior, it may be preferred to interact with the guardian's App 164 on a smartphone, the query to the smartphone App being sent immediately upon the system's recognition of a uniquely familiar movement data stream with questions that will help solidify the machine learning understanding of what desire, want or need that particular dog's data stream should correlate to. The dog's profile record is thereby updated with the guardian's confirmation.

One expert system as previously described includes a library of natural language phrases representative of a dog's wants, needs or desires. In the example of a dog needing to go outside to pee as just described, the pet behavior system, upon recognizing the data stream associated with going outside to pee will cause the phrase “I need to go out to go pee” to be played on an internet connected speaker 165, thereby providing an audible request to the guardian in a language understandable to the guardian.

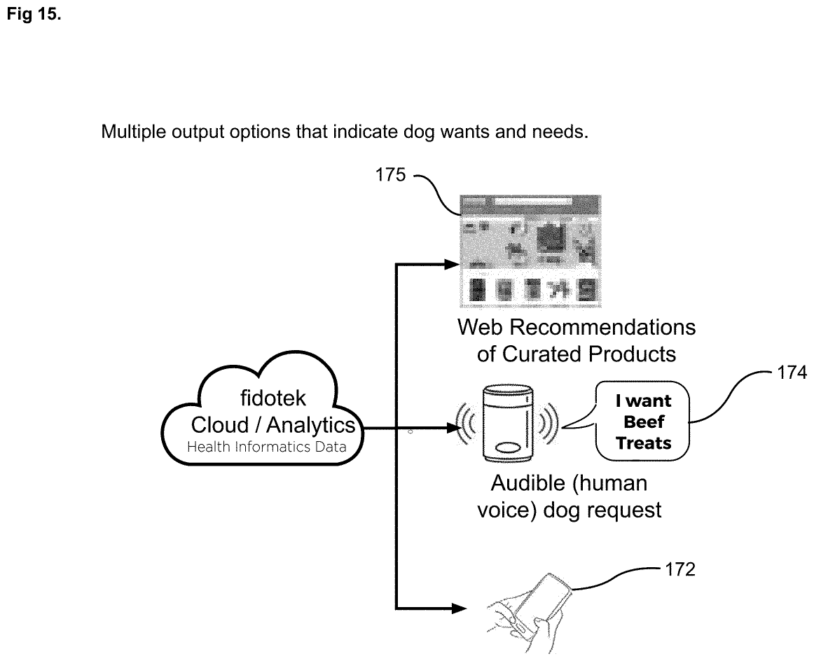

FIG. 13 is an exemplary diagram showing a system of a recommendation machine. Sensor data from IoT devices 166 is captured in the cloud based pet behavior system 167. Machine analysis is performed on the pet data 169, and further performed on the products data 168. Products that positively correlate to the dog's needs, wants or desires as previously described are recommended to the guardian for purchase 171, 171, 172. The product is delivered 173 to the dog's home by one of many well-known means. After receipt of the recommended product or service by the guardian, and experienced by the dog, another data collection 166 transpires for the purpose of comparing the previous data that prompted the recommendation to the post-use data as a means of determining the performance of the product or service against the expected performance.

More specifically, the recommendation machine provides for the evaluation of performance, efficacy or satisfaction of a dog product by means of comparative analysis of data collected from a plurality of sensors associated with the dog, the comparative data analysis consisting of dog behavior data computed prior to subsequent to the receipt and use of the product by the dog compared to dog behavior data collected subsequent to receipt and use of the product that was purchased as a result of the Recommendation Machine 166.

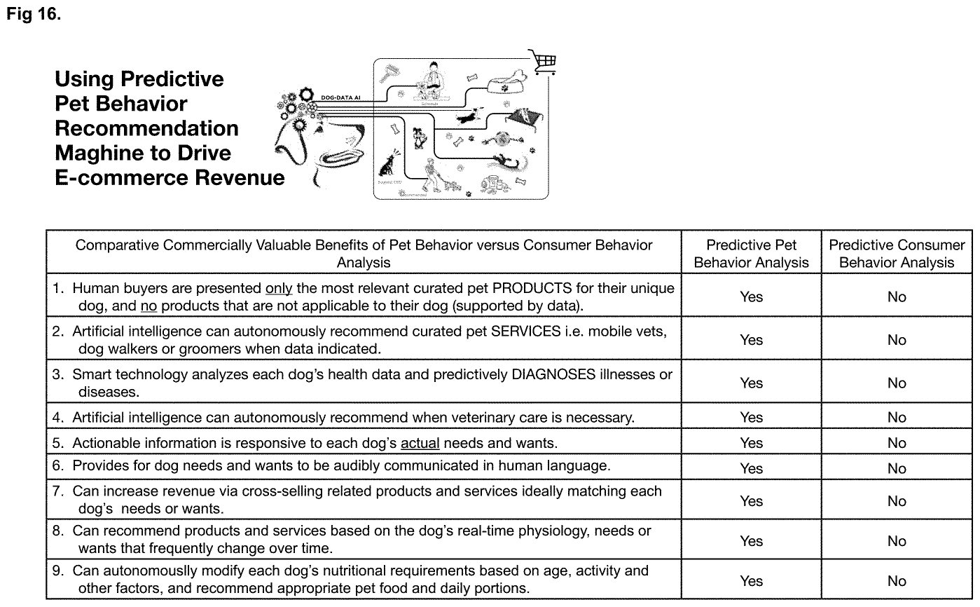

FIG. 14 is an exemplary diagram showing examples of various dog positions and movements that generate unique IoT device data streams that are machine learned in the cloud databases previously described, the data streams corresponding to a plurality of various behaviors, feelings and/or emotions as previously described in detail. Further, the bubble 174 in the illustration contains various phrases that may be played over an internet connected speaker, the phrases being played in human language with each phrase representative of a particular pet data need, wish or desire over an internet connected speaker 165, the phrases representing the dog's feelings, wants, needs or desires as previously described.

It should be noted that the human language phrases may be recorded in various formats including multiple languages, voice gender and accents, the voice preference selected by the guardian via a smartphone app 172.

Therefore, the avatar voice invention provides for correlating the expert system of interpreted dog behavior and feelings with a library of an unrestricted number of digitally recorded phrases in a preferred natural language, the phrases being proxy communication for a dog such that each phrase typifies at least one expression of a dog's wants, needs or desires as determined by a dog behavior machine.

Those skilled in the art will appreciate that providing the ability for dogs to engage in interactive communication with their guardians using human language would provide one of the most important advancements in the 5,000 year evolutionary history of man's relationship with dogs.

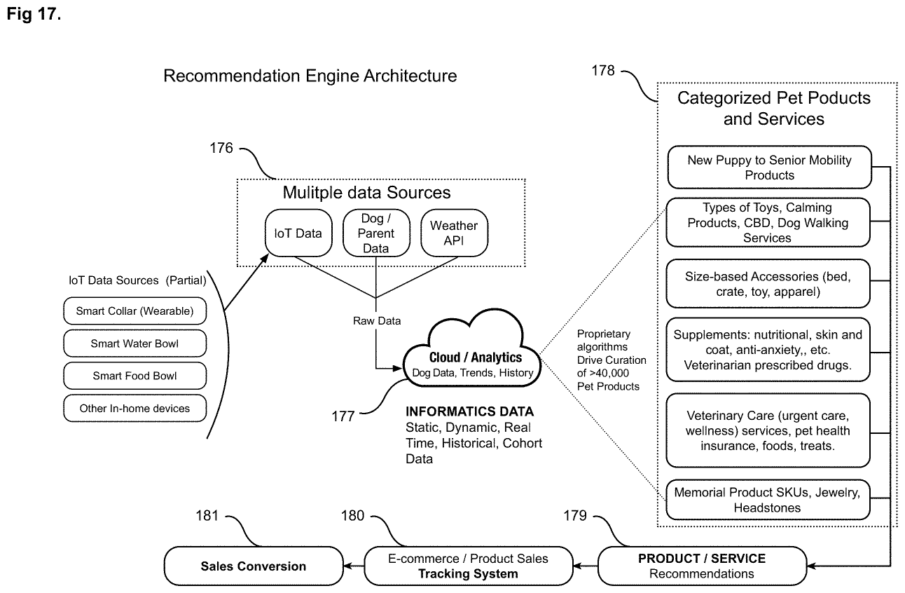

FIG. 15 is an exemplary diagram showing various possible outputs from the dog behavior and product/service recommendation machine. More specifically, based on the analysis of the dog behavior system, the recommended products may be displayed on an ecommerce website 175, or delivered audibly via a speaker 174 or a digital message on a connected device 172.

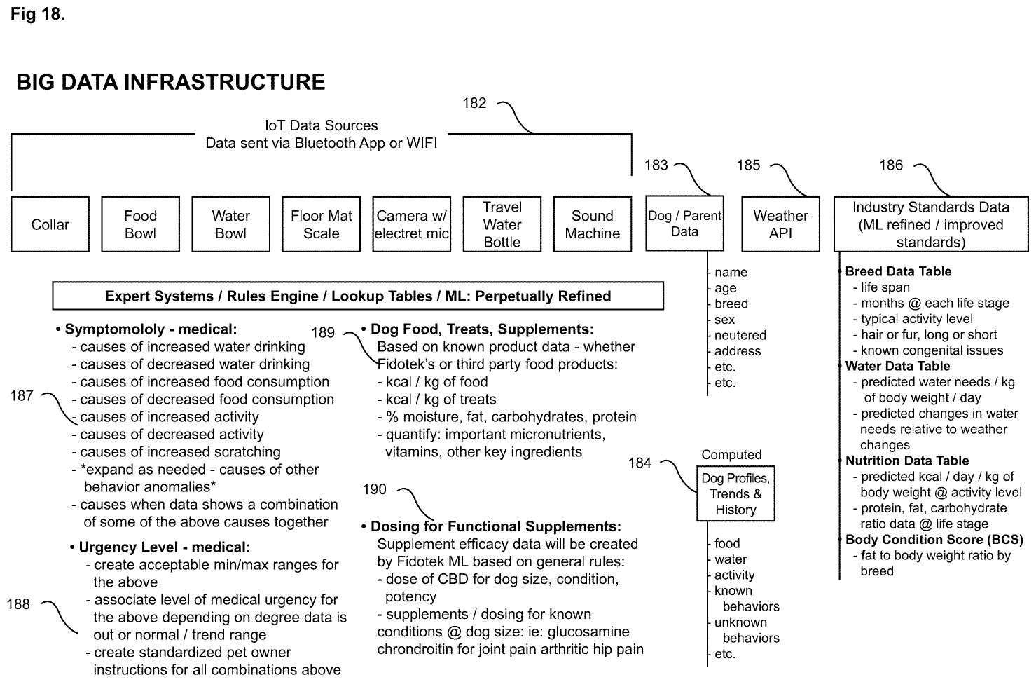

FIG. 16 is an exemplary diagram showing a table listing benefits of a predictive pet behavior recommendation machine to drive E-commerce revenue.

It is well known that over 30% of Amazon's revenue is generated as a result of its recommendation machine that is based on analysis of human behavior. A recommendation machine is therefore highly valuable commercial asset that promotes customer retention and growth, lowers the rate of customer churn, increase repeat purchases and cross-category product sales, and improves customer satisfaction and loyalty. However, as previously discussed, analyzing human behavior does not substantially increase the sale of products or services that each unique pet would want or need.

When applied to online commerce, the commercially important differences between curating and recommending products and services based on pet behavior analysis and consumer behavior analysis could not be more significantly different.

Shortening the path from web search to consumer purchase of individual dog related products and services by personalizing each product and/or service for each individual dog based on current dog behavior data increases customer confidence in the search results, and hence, accelerates the purchase decision. The recommendation machine shortens the decision-making process as to which products or services the dog wants or needs, thereby creating a more pleasurable customer experience that leads to improved sales metrics for the seller of the products and services.

Use Customer Behavior Data to Increase Customer Retention/Reduce Churn. Customers who become psychologically dependent on the knowledge base that contains their dog's behavior and best pet care recommendations for appropriate, curated products and services are less apt to leave a dog-data driven service, therefore increasing customer retention and correspondingly increasing the commercial lifetime value of the customer.

A pet behavior driven recommendation machine can more easily cross-sell products that customers don't know they want because the enhanced, more accurate matching between the unique pet data and corresponding products and services.

The novel recommendation machine preferably incorporates “past behavior”, but importantly includes current dog behavior to alert guardians of a dog's immediate wants and needs based on the pet's current data, and predict future needs and wants based on continually analyzed dog behavior data, trend data, anomalous data, and comparative data from similar dogs in a large cohort of dogs.

As one example of predictive product recommendation, the present invention predicts a future type of food that should be ordered. For instance, as a dog ages its metabolism and nutritional requirements change. A puppy food that contains a certain protein, fat, fiber, nutrient and caloric recipe that puppies need to fuel early stage growth preferably changes to an adult recipe when a dog advances in age to adulthood wherein the ratio of protein, fats, fiber and nutrients change. The dog behavior data for each dog predicts the point in time when a food recipe should change in anticipation of a dog advancing through each of the four commonly recognized life stages.

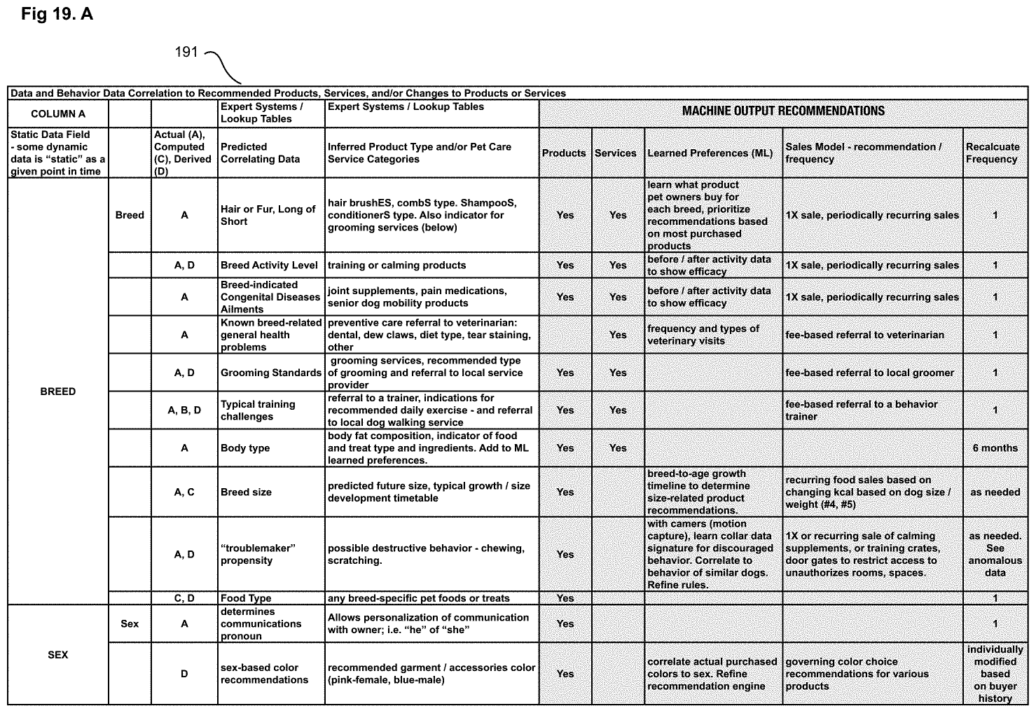

FIG. 17 is an exemplary diagram showing a correlation between a partial list of dog characteristics and the influence of the characteristics on a partial list of categories of dog products and services, the recommendation of the products and/or services thereby driving an online ecommerce portal. The novel recommendation machine further provides for tracking the purchased product or service that was recommended, and whether the recommendation resulted in a sales conversion.

Pet data directly and indirectly acquired from multiple sources 176 and analyzed in the cloud 177 using rules as previously described. This informatics data may be correlated to a virtually unlimited inventory of categorized products and services 179 that can be purchased online for each pet, and more specifically, the recommended products and/or services 179. It should be noted that the product and service categories shown for reference are not meant to be limiting.

To improve customer performance metrics, the recommended products are tracked and compared to the products purchased by the pet guardian 180, with the products showing a higher recommended: purchases ratio being prioritized for recommendation to future customers who have dogs exhibiting similar wants or needs to further increase the sales conversion ratio 181.

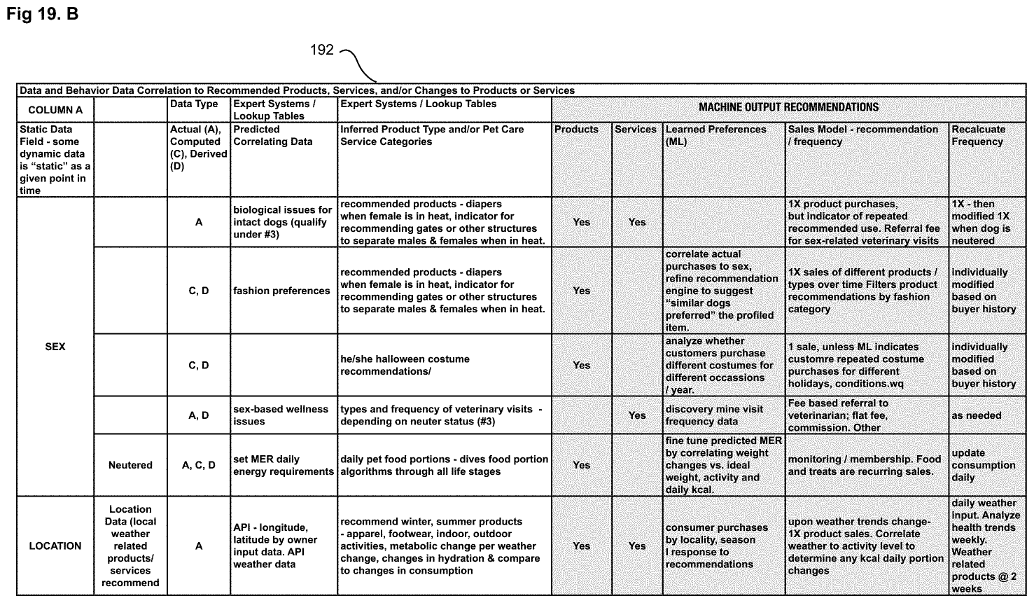

FIG. 18 is an exemplary diagram showing various components of the predictive dog behavior analytics system previously described. It should be noted that the following description is not meant to be limiting and any number of elements may be added, removed and/or combined as may be preferred for dog behavior analysis. IoT devices 182 are preferably located proximate to a dog for which unique pet data is stored, the unique dog and guardian data 183 comprising data manually introduced into the database by means of keyboard entries or voice-to-text entries. Additional pet data is computed 302 using one or more algorithms applied to the IoT data thereby deriving additional current and historical data unique to a given dog by computing profiles, trends and histories 184.

Various expert systems may include localized weather data 185, industry standards listing or tables 186, symptomology lookup database 187, and a rules engine that determines the predicted level of urgency 188 of the cause of the symptoms, food and treats nutrition data 189 and tables 190 that contain a predicted appropriate dosing of supplements and/or medicaments.

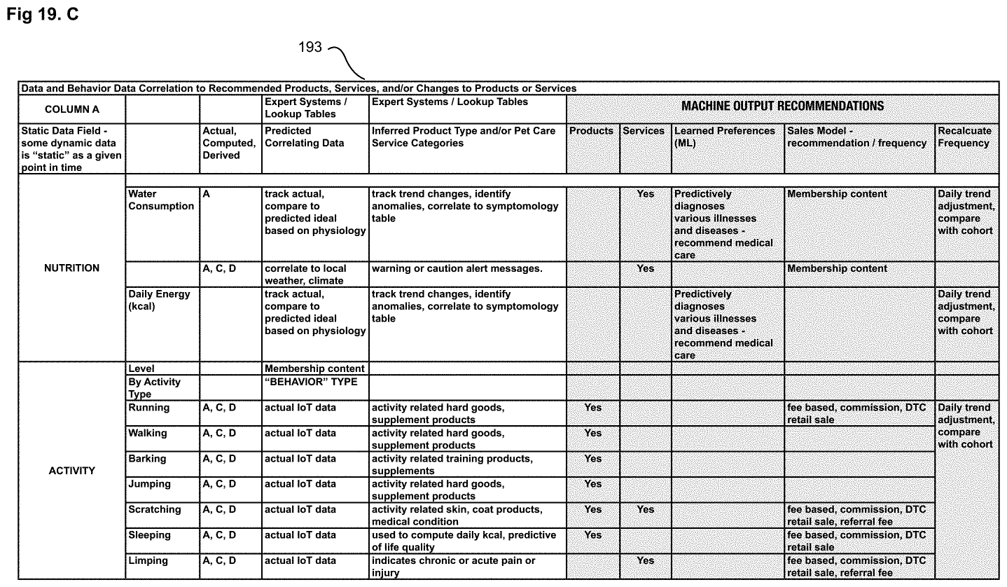

FIG. 19A is an exemplary diagram showing a table 191 of data fields, the type of data (actual raw data, derived data or the product of computed raw data), an associated expert knowledgebase and lookup tables, and whether the recommendation engine should recommend a product and/or service for the given data set.

More specifically, the right column indicates a preferred frequency of data recalculation to ensure that recommendations made are current and relevant relative to the current data. For instance, since it is known that a given dog is of male gender, it is not necessary to recompute gender to determine whether gender has changed. However, since the dog eats and drinks every day, daily computation is important to discover whether behavior is consistent with the predicted data, whether the data is consistent with the dog's historical data, or whether the data represents an anomaly indicative of an emergency, or whether it establishes a new baseline of pet health and behavior data that requires that the guardian take some action.

In the drawing, the left-most column shows BREED, wherein the breed references a breed database previously described, the breed database containing certain characteristics of each different breed that are used to identify correctly personalized products or services to the owner of the breed. Those familiar with breed characteristics will immediately appreciate that any one or all of the characteristics can be positively correlated to specific products or services used more by one particular breed compared to another breed. As one example, of the many dozens of hair grooming brushes available, correlating breed characterizes to a database dog brushes would recommend a long-toothed comb for a long-haired breed, such as a golden retriever, but a short toothed comb or brush for a short hair breed such as a Beagle.

FIG. 19B is an exemplary diagram showing a table 192 of data fields, the type of data (actual raw data, derived data or the product of computed raw data), an associated expert knowledgebase and lookup tables, and whether the recommendation engine should recommend a product and/or service for the given data set.

As one example of correlating a dog's real-time geographic location data to a products and services database, it will be immediately appreciated that recommended product purchases may include dog booties or cold weather garments when the weather data indicates wintertime, or a particular cold day, and conversely would recommend dog drinking water bottles during the summer when the dog is accompanying its guardians on a summer hike or outing.

FIG. 19C is an exemplary diagram showing a table 193 of data fields, the type of data (actual raw data, derived data or the product of computed raw data), an associated expert knowledgebase and lookup tables, and whether the recommendation engine should recommend a product and/or service for the given data set.

More specifically, the recommendation machine not only provides for identifying the most preferred pet food for each pet, but may also further analyze the behavioral data to recommend the daily portions of that food responsive to real-time or near real-time daily and long-term changes in the pet's behavior.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

At least one embodiment of the method and machine for predictive animal behavior analysis is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, the computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the method and machine for predictive animal behavior analysis will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the method and machine for predictive animal behavior analysis, suitable methods and materials are described above. Thus, the method and machine for predictive animal behavior analysis is not intended to be limited to the embodiments shown, but is to be accorded the widest scope consistent with the principles and features disclosed herein.

What is claimed is:

1. A system for recommending a pet deliverable for a pet, comprising:
a sensor associated with a pet, wherein the sensor acquires a pet behavior data of the pet corresponding to at least one behavior of the pet;
a database storing a plurality of pet behaviors and a plurality of corresponding deliverables;
a server computer in communication with the sensor and the database, wherein the sensor is configured to communicate the pet behavior data for the pet to a server computer and wherein the server computer is configured to compare the pet behavior data to the plurality of pet behaviors in the database to identify at least one selected deliverable from the plurality of corresponding deliverables that corresponds to the pet behavior data; and
a computer device accessible by a guardian of the pet, wherein the server computer communicates to the computer device the at least one selected deliverable and wherein the computer device communicates the at least one selected deliverable to the guardian of the pet.

2. The system of claim 1, wherein the deliverables are a pet product or a pet service.

3. The system of claim 1, wherein the sensor is comprised of an accelerometer.

4. The system of claim 1, wherein the sensor is comprised of a biometric sensor.

5. The system of claim 1, wherein the sensor is comprised of an audio sensor.

6. The system of claim 1, wherein the sensor is comprised of a video sensor.

7. The system of claim 1, wherein the sensor is adapted to be physically attached to the pet.

8. The system, of claim 1, wherein the server computer communicates a purchase option for the at least one selected deliverable.

9. The system of claim 8, wherein the server computer is configured to determine if the guardian has purchased or received the at least one selected deliverable.

10. The system of claim 9, wherein the server computer is configured to monitor the pet behavior data of the pet after the at least one selected deliverable has been purchased or received by the guardian.

11. The system of claim 10, wherein the server computer is configured to determine if the pet behavior data corresponds to a changed behavior in the at least one behavior of the pet.

12. The system of claim 11, wherein the server computer is configured to use the changed behavior to determine a future deliverable recommendation.

13. The system of claim 1, wherein the computer device is configured to communicate the at least one selected deliverable to the guardian of the pet using audible words.

14. A system for recommending a pet deliverable for a pet, comprising:
a sensor associated with a pet, wherein the sensor acquires a pet behavior data of the pet corresponding to at least one behavior of the pet;
a database storing a plurality of pet behaviors and a plurality of corresponding pet needs;
a server computer in communication with the sensor and the database, wherein the sensor is configured to communicate the pet behavior data for the pet to a server computer and wherein the server computer is configured to compare the pet behavior data to the plurality of pet behaviors in the database to identify at least one selected pet need from the plurality of corresponding pet needs that corresponds to the pet behavior data; and
a computer device accessible by a guardian of the pet, wherein the server computer communicates to the computer device the at least one selected pet need and wherein the computer device communicates the at least one selected pet need to the guardian of the pet.

15. The system of claim 14, wherein the deliverables are a pet product or a pet service.

16. The system of claim 14, wherein the sensor is comprised of an accelerometer.

17. The system of claim 14, wherein the sensor is comprised of a biometric sensor.

18. The system of claim 14, wherein the sensor is comprised of an audio sensor or a video sensor.

19. The system of claim 14, wherein the sensor is adapted to be physically attached to the pet.

20. The system of claim 14, wherein the computer device is configured to communicate the at least one selected pet need to the guardian of the pet using audible words.
